(19) United States
(12) Patent Application Publication
(10) Pub. No.: US 2010/0044266 A1
(43) Pub. Date: Feb. 25, 2010

(54) Polyester Blends

(75) Inventors: Geraldine M. Lenges, Wilmington, DE (US); Joseph V. Kurian, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Willimgton, DE (US)

(21) Appl. No.: 12/197,013

(22) Filed: Aug. 22, 2008

(51) Int. Cl. B32B 1/02; B65D 85/00; B65D 85/72

(52) U.S. Cl. 206/524.6; 428/35.7; 426/115

(57) ABSTRACT

Disclosed are molded articles comprising a thermoplastic polymer composition comprising, consisting essentially of, or prepared from (a) about 30% to about 99 weight % based on the combination of (a) and (b) of a poly(ethylene terephthalate) homopolymer or copolymer; and (b) about 1 to about 70% weight % based on the combination of (a) and (b) of a poly(trimethylene terephthalate) homopolymer or copolymer. Specific embodiments include injection-molded preforms and blown bottles.

This invention relates to polyester blend compositions containing poly(trimethylene terephthalate) and poly(ethylene terephthalate), useful for making shaped articles such as bottles and other blown products using injection stretch blow molding processes.

### BACKGROUND OF THE INVENTION

The most common polyester currently used is poly(ethylene terephthalate) (PET). It is widely used in the manufacture of shaped articles such as bottles, containers, compression- or injection-molded parts, tiles, films, engineered components, etc. Due to recent trends toward sustainability and reduced use of petroleum, alternatives to PET are being investigated.

A common package currently made from PET is an injection-stretch-blow-molded (ISBM) bottle, jar or other container. In an ISBM process, the polymer resin is heated to the molten form in an extruder and then injection-molded in a mold to provide a “preform” or parison. The preform is then heated and stretched or expanded by application of air pressure to its final shape.

Poly(trimethylene terephthalate) (3GT, also referred to as PTT or polypropylene terephthalate) may be prepared using 1,3-propanediol derived from petroleum sources or from biological processes using renewable resources (“bio-based” synthesis). The ability to prepare 3GT from renewable resources makes it an attractive alternative to PET.

3GT may be useful in many materials and products in which polyesters such as PET are currently used, for example molded articles. It has recently received much attention as a polymer for use in textiles, flooring, packaging and other end uses. Because of the different properties of 3GT compared to PET, it may be difficult to simply substitute 3GT for PET in processes designed to use PET.

3GT has not yet found wide application in bottles, containers and other molded goods despite having many superior properties compared to PET. For example, it has improved surface gloss and better barrier characteristics against water vapor, flavors and gases, characteristics which may be an advantage over PET in bottles and containers.

3GT has not received wider use in these shaped article applications in spite of its excellent end-use properties (e.g., in fibers) because the preparation of shaped articles such as bottles and containers by compression-, injection- or blow-molding requires high melt strength and/or melt viscosity, a property which has not been consistently achieved with the 3GT polymers currently described in the art. 3GT polymers also have lower glass transition temperatures than PET, limiting the use temperature of 3GT bottles.

JP56-146738A discloses bottles made from PET where no more than 20 mole % of the ethylene glycol used in its preparation may be replaced by other diols such as trimethylene glycol. Also disclosed is the use of 2 mole % or less of polyols and/or polycarboxylic acids such as trimethylolpropane, pentaerythritol, trimellitic acid, and trimesic acid. JP3382121B discloses the use of polyols such as trimethylolpropane, pentaerythritol, glycerine, etc., and polybasic acids such as trimellitic acid and pyromellitic acid in preparation of polyester at the level of 0.1 to 5 mole % of the reactants. The diols disclosed for use in preparing the polyesters are ethylene glycol, diethylene glycol, triethylene glycol, propylene glycol, 1,4-butanediol, 1,6-hexanediol, neopentyl glycol, dimer diol, cyclohexanediol, cyclohexane dimethanol, and their ethylene oxide addition products. JP2003-12813A discloses the use of polyols and/or polybasic acids at a level of 1 mole % or less, preferably 0.5 mole % or less, as a branching component in 3GT with improved moldability.

Poly(trimethylene dicarboxylate) and shaped articles have been disclosed (see, e.g., U.S. Pat. No. 7,396,896, U.S. Pat. No. 7,052,764, JP2004-300376, and JP2006-290952). Mixtures of PET homopolymer or copolymer and PPT homopolymer or copolymer and films prepared therefrom have also been disclosed (see, e.g., U.S. Pat. Nos. 6,663,977 and 6,902,802).

In order to obtain as much “bio-based” content in packaging materials as possible by substituting 3GT for PET, it is desirable to develop compositions that allow the use of 3GT in ISBM processes while maintaining the properties available from bottles prepared solely from PET or PET copolymers. It is also desirable that post-consumer PET may be used in the compositions, to provide a reduced environmental footprint. Another desirable characteristic of blown bottles is good clarity and/or transparency.

### SUMMARY OF THE INVENTION

A thermoplastic composition comprising, consisting essentially of, or produced from about 30 to about 99 weight % of a poly(ethylene terephthalate) and about 1 to about 70 weight % of a poly(trimethylene terephthalate) wherein the weight % is based on the weight of the composition; the composition does not contain a crystallization accelerator; and the composition may be a pellet blend or melt extruded blend.

A molded article comprising or prepared from the composition disclosed above. Specific embodiments include injection-molded preforms and blown bottles, vials, jars and other containers.

### DETAILED DESCRIPTION OF THE INVENTION

The following definitions apply to the terms as used throughout this specification, unless otherwise limited in specific instances.

The technical and scientific terms, unless otherwise indicated, have the meanings that are commonly understood by one of ordinary skill in the art to which this invention belongs. Tradenames or trademarks are in uppercase.

As used herein, the term “produced from” is synonymous to “comprising”.

Homopolymer means a polymer containing many repeat units of one kind. For example, a 3GT homopolymer means a polymer substantially derived from the polymerization of 1,3-propanediol with terephthalic acid, or alternatively, derived from the ester-forming equivalents thereof (e.g., any reactants such as dimethyl terephthalate which may be polymerized to ultimately provide a polymer of poly(trimethylene terephthalate).

Copolymer refers to polymers comprising repeat units of two or more different kinds. For example, a 3GT copolymer means any polymer comprising (or derived from) at least about 70 mole % trimethylene terephthalate and the remainder of the polymer being derived from monomers other than terephthalic acid and 1,3-propanediol (or their ester forming equivalents).

All references are incorporated by reference as if fully set forth herein.

The composition may comprise about 1 to about 70 weight % of 3GT, about 20 to about 70, 1 to about 60, about 1 to about 45, about 5 to about 35, about 10 to about 30, about 15 to about 30, or about 20 to about 30 weight % of 3GT (for example, 27 weight % of 3GT) and the rest can comprise PET.

Polyester polymers are well known to one skilled in the art and may include any condensation polymerization products derived from, by esterification or transesterification, an alcohol and a dicarboxylic acid including ester thereof. Alcohols include glycols having 2 to about 10 carbon atoms such as ethylene glycol, propylene glycol, butylene glycol, methoxypolyalkylene glycol, neopentyl glycol, trimethylene glycol, tetramethylene glycol, hexamethylene glycol, diethylene glycol, polyethylene glycol, cyclohexane dimethanol, or combinations of two or more thereof. Dicarboxylic acids include terephthalic acid, succinic acid, adipic acid, azelaic acid, sebacic acid, glutaric acid, isophthalic acid, 1,10-decanedicarboxylic acid, phthalic acid, dodecanedioic acid, the ester-forming equivalents (e.g., diesters such as dimethylterephthalate), or combinations of two or more thereof.

Polyethylene terephthalate is a polyester prepared by the condensation polymerization of ethylene glycol and terephthalic acid (or dimethyl terephthalate). The PET may be a PET homopolymer or a copolymer that preferably contains 70% or more of poly(ethylene terephthalate) in mole percentage, or blends thereof. These may be modified with up to 30 mol percent of polyesters made from other diols or diacids

Poly(trimethylene terephthalate) is a polyester that may be prepared by the condensation polymerization of 1,3-propanediol and terephthalic acid. A 3GT may also be prepared from 1,3-propane diol and dimethylterephthalate (DMT), for example, in a two-vessel process using an organotitanate catalyst, e.g., tetraisopropyl titanate catalyst, TYZOR TPT (E.I. du Pont de Nemours and Company (DuPont), Wilmington, Del.). Molten DMT is added to 1,3-propanediol and the catalyst at about 185° C. in a transesterification vessel, and the temperature is increased to 210° C. while methanol is removed. The resulting intermediate is transferred to a polycondensation vessel where the pressure is reduced to one millibar (10.2 kg/cm²) and the temperature is increased to 255° C. When the desired melt viscosity is reached, the pressure is increased and the polymer may be extruded, cooled and cut into pellets.

The 3GT may be a homopolymer or a copolymer that preferably contains 70% or more of 3GT in mole percentage, or blends thereof. These may be modified with up to 30 mol % of polyesters made from other diols or diacids. The most preferred resin is 3GT homopolymer.

Other diacids that are useful to polymerize 3GT resin include isophthalic acid, 1,4-cyclohexane dicarboxylic acid, 1,3-cyclohexane dicarboxylic acid, succinic acid, glutaric acid, adipic acid, sebacic acid, 1,12-dodecane dioic acid, and the derivatives thereof such as the dimethyl-, diethyl-, dipropyl esters of these dicarboxylic acids, or combinations of two or more thereof.

Other diols include ethylene glycol, 1,4-butanediol, 1,2-propanediol, diethylene glycol, triethylene glycol, 1,3-butanediol, 1,5-pentanediol, 1,6-hexanediol, 1,2-, 1,3- and 1,4-cyclohexane dimethanol, the longer chain diols and polyols made by the reaction product of diols or polyols with alkylene oxides, or combinations of two or more thereof.

Because polyesters and processes for making them are well known to one skilled in the art, further description is omitted herein for the interest of brevity.

Intrinsic viscosity (IV) is a measure of the capability of a polymer in solution to enhance the viscosity of the solution. IV may be measured according to ASTM D2857.95. For example, a Viscotek Forced Flow Viscometer model Y-900 may be used and the polymers dissolved in 50/50 w/w trifluoroacetic acid/methylene chloride at a 0.4% (wt/vol) concentration and tested at 19° C. Intrinsic viscosity typically increases with increasing polymer molecular weight, but is also dependent on the type of macromolecule, its shape or conformation, and the solvent it is measured in. Because 3GT and PET polymers have different shapes, 3GT has higher IV than PET for a given molecular weight. For example, 3GT with IV of about 1.0 corresponds to PET with IV of about 0.7.

Differential Scanning Calorimetry (DSC) may be used to determine glass transition temperature (Tg), temperature of crystallization from the glass or cold crystallization (Tcg or Tcc), crystallization from the melt, and melting point (Tm). A 10-mg sample of polymer, ground to pass a 20-mesh (7.9 cm⁻¹) screen, was analyzed with a TA Instruments 2920 DSC, with a refrigerated cooling accessory for controlled cooling, from room temperature to 280° C. using a heating rate of 10° C./min. The sample was then held at 280° C. for two minutes, quenched in liquid nitrogen, and then reheated from room temperature to 280° C. Procedures for measurement of Tg, Tcc or Tcg, and Tm were used as described in the TA Instruments manual for the 2920 DSC.

A practical processing window for thermoplastic materials may be the temperature range between Tg and Tcc or Tcg. 3GT has a relatively narrow processing window. Blends of 3GT and PET provide a broader processing window by shifting the crystallization temperature from glass to a higher temperature region.

The low Tg polyester compositions may be used to produce dimensionally-stable ISBM bottles with shrinkage in height and diameter that are statistically equivalent to the control, higher-Tg PET copolymer resin.

Of note are compositions wherein the Tg is from about 45 to about 90° C. and the Tcg is from about 70° C. to about 150° C., as determined by differential scanning calorimetry by heating from room temperature to 280° C. using a heating rate of 10° C./min, holding at 280° C. for two minutes, cooling to below room temperature, and then reheating from room temperature to 280° C. Also of note are compositions wherein the Tg is from about 45 to about 80° C. and the Tcg is from about 70 to about 130, and compositions wherein the Tg is from about 65 to about 80° C. and the Tcg is from about 90 to about 150.

The compositions may additionally comprise small amounts of optional materials commonly used and well known in the polymer art. Such materials include conventional additives used in polymeric materials including plasticizers, stabilizers including viscosity stabilizers and hydrolytic stabilizers, primary and secondary antioxidants such as for example IRGANOX 1010, ultraviolet ray absorbers and stabilizers, anti-static agents, dyes, pigments or other coloring agents, fire-retardants, lubricants, processing aids, slip additives, antiblock agents such as silica or talc, release agents, and/or mixtures thereof. Additional optional additives may include inorganic fillers; acid copolymer waxes, such as for example Honeywell wax AC540; TiO₂, which is used as a whitening agent; optical brighteners; surfactants; and other components known in the art to be useful additives. These additives are described in the Kirk Othmer Encyclopedia of Chemical Technology.

Additives such as antioxidants (e.g., hindered phenols characterized as phenolic compounds that contain sterically bulky radicals in close proximity to the phenolic hydroxyl group) may be used. Hindered phenols may include 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis-(2,6-tert-butyl-phenol); 4,4′-thiobis-(8-tert-butyl-o-cresol); 2,6-di-n-tert-butylphenol; 6-(4-hydroxyphenoxy)-2,4-bis(n-octyl-thio)-1,3,5 triazine; di-n-octylthioethyl-(3,5-di-tert-butyl-4-hydroxy)-benzoate; sorbitol hexa[3-(3,5-di-tert-butyl-4-hydroxy-phenyl)-propionate], or combinations of two or more thereof. An antioxidant of note is bis-(2,4-di-t-butylphenyl) pentaerythritol diphosphite, CAS Number 26741-53-7, available under the tradename ULTRANOX 626 from Chemtura.

These additive(s) may be present in the compositions in quantities that are generally from 0.01 to 15 weight %, preferably from 0.01 to 10 weight %, so long as they do not detract from the basic and novel characteristics of the composition and do not significantly adversely affect the performance of the composition (the weight percentages of such additives are not included in the total weight percentages of the compositions as defined above in the Summary of the Invention). Many such additives may be present in amounts from 0.01 to 5 weight %.

The optional incorporation of such additives into the compositions may be carried out by any known process, for example, by dry blending, by extruding a mixture of the various constituents, by the conventional masterbatch technique, or the like.

Compositions described herein do not contain crystallization accelerators, also known as nucleating agents or nucleators. The compositions are used in preparing injection molded preforms, which desirably comprise amorphous polymer compositions to allow for orientation in a subsequent blowing step (see below). Accordingly, use of crystallization accelerators that promote crystallization is undesirable. In addition, crystallization accelerators may reduce transparency and/or clarity of the shaped articles.

The composition may be prepared by blending the components by any means known to one skilled in the art, e.g., dry blending/mixing, extrusion, co-extrusion, to produce the composition. The composition may be a pellet blend or melt extruded blend. The composition may be prepared by a combination of heating and mixing (melt-mixing or melt-blending). For example, the component materials may be mixed to be substantially dispersed or homogeneous using a melt-mixer such as a single or twin-screw extruder, blender, Buss Kneader, double helix Atlantic mixer, Banbury mixer, roll mixer, etc., to give a resin composition. Alternatively, a portion of the component materials may be mixed in a melt-mixer, and the rest of the component materials subsequently added and further melt-mixed until substantially dispersed or homogeneous.

For example, a salt and pepper blend of the components may be made and the components may then be melt-blended in an extruder. Alternatively, the components may be fed to the extruder separately and melt-blended.

The shaped articles may comprise materials other than the polyester blend, such as layers of polymeric material other than the polyester blend, or nonpolymeric substrates. For example, articles such as preforms may be prepared by coinjection molding wherein two or more melt streams are injected into a mold in such a way that one polymeric material (for example, the more expensive and/or more functional material) is on the exterior of the article while another polymer is in the interior.

Various additives may be present in the respective layers including the presence of tie layers including antioxidants and thermal stabilizers, ultraviolet light stabilizers, pigments and dyes, fillers, anti-slip agents, plasticizers, other processing aids, and the like may be employed in the other layers.

Hollow shaped articles such as bottles may be produced from the polyester blend composition using an ISBM process. This is a process used in the polymer industry for converting polymer resin into bottles. In an ISBM process, the polymer resin is heated to the molten form in an extruder and then injection-molded in a mold to provide a “preform” or parison. A preform or parison is a substantially tubular hollow article having a closed end and an open end having relatively thick walls that is adapted for subsequent blow molding into a finally desired container form. The preform may be produced with the neck of the bottle, including threads or other means for attaching as closure (the “finish”) on one end. The preform mold is ideally maintained at a temperature below the Tg of the polymer resin, which enables the polymer to be quenched in the amorphous phase.

To prepare a bottle, the preform may be reheated and biaxially expanded by axial stretching and radial stretching in a blow molding operation (see below), usually in a shaped mold so that it assumes the desired configuration. The neck region is unaffected by the blow molding operation while the bottom and particularly the walls of the preform are stretched and thinned. The resulting thickness of the exterior layers and the interior layers may provide sufficient strength and barrier properties to allow the bottle to contain and protect the product packaged within.

In the blowing step, the walls of the preforms are heated (for example using infrared heaters) above their Tg, then blown and stretched using high pressure air into the final bottle shape using metal blow molds having an inner volume equal to the size and shape of the desired bottle. The preform may also be stretched axially (lengthwise) with a core rod as part of the process.

This process involves the production of hollow objects, such as bottles, jars and other containers having biaxial molecular orientation (radial and axial). Biaxial orientation allows bottles to resist deforming under the pressures formed by carbonated beverages, which may approach 60 psi. Biaxial orientation provides enhanced physical properties such as higher mechanical strength and rigidity, clarity (transparency), and gas barrier properties, which are all very desirable in products such as bottles, vials, jars and other containers.

There are two types of stretch-blow-molding techniques. In the one-stage process, preforms are injection molded, conditioned to the proper temperature, and blown into containers all in one continuous process. This technique is most effective in specialty applications, such as wide-mouthed jars, where very high production rates are not a requirement.

In the two-stage process, preforms are injection molded, stored for a short period of time (for example 1 to 4 days), and blown into containers using a reheat-blow (RHB) machine. Because of the relatively high cost of molding and RHB equipment, this is the best technique for producing high-volume items such as carbonated beverage bottles.

Vials, bottles, jars and other containers comprising the polyester blend composition may be prepared, as described above, by injection-stretch-blow-molding. Liquids that may be packaged in vials, bottles and jars include cosmetics, lotions, perfumes, beverages, including carbonated soft drinks and pasteurized beverages such as beer, milk and other dairy products, edible oils, syrups, sauces, mayonnaise, peanut butter, purees such as baby foods, vinegar, lemon juice and pharmaceuticals, personal hygiene products, and medicaments. Petroleum products including motor oil, fuels such as gasoline, and household chemicals, including bleaches, soaps, detergents, agrochemical products, and the like may also be packaged in the bottles. Powders, granules and other flowable solids may also be packaged in the bottles.

Bottle and/or jar sizes, for example, may range from under 2-ounce to 128-ounce capacity or larger. Although containers are generally described herein as bottles, other containers such as vials, jars, drums and fuel tanks may be prepared as described herein from the compositions described herein. Larger capacity containers such as drums or kegs are also suitable, as are smaller vials, bottles and other containers.

Molded articles may be produced from a composition disclosed above, by virtually any method of extrusion processing or thermoforming known to those skilled in this art. For example, a melt extrusion process such as injection molding, coinjection molding, compression molding, overmolding and profile extrusion may be used. As such, the articles may be injection molded, compression molded, profile extruded or the like. Injection-molded articles are of note.

The article disclosed above has reduced heat deformation or shrinkage, as compared to an article made from 3GT or a composition comprising more than 50 wt % 3GT, when the article is aged at high temperature of about 30 to about 55° C. or about 35 to about 45° C. and at a high relative humidity of from about 60 to about 100, about 70 to about 100, or about 80 to about 95%. In other words, the article is a heat stable article where the article is substantially the same as an article made from PET in heat deformation or shrinkage. Furthermore, byproducts such as acrolein, is absent from the article.

### EXAMPLES

The Examples are illustrative and are not to be construed as to unduly limit the scope of the invention.

Materials: 3GT-1: a poly(trimethylene terephthalate) homopolymer with melt temperature of 228° C., Tg of about 50° C. and IV of 1.02, obtained from DuPont under the BIOMAX or SORONA tradenames; PET-1: a polyethylene terephthalate copolymer having a melt temperature of 244° C. and relatively low IV (0.76), a water-bottle-grade resin, obtained under the tradename AQUA RH314 from Eastman Chemicals, Kingsport, Tenn.: PET-2: a polyethylene terephthalate copolymer (1.8 mol % 1, 4-cyclohexanedimethanol and 1.4 mol % diethylene glycol) having a low melt temperature (240° C.) and relatively low IV (0.78), a water-bottle-grade resin, obtained as Eastman PET 9921P.
Detailed Procedure: 3GT-1 was dried and crystallized at 120° C. for 48 hours. Prior to processing, 3GT-1 was re-dried at 100° C. in a vacuum oven for a minimum of 2 hours. Karl Fischer analysis indicated a moisture level of 8.2 ppm for 3GT-1 immediately prior to injection-molding. Blends of 3GT-1 and PET-2 were prepared by melt blending in an extruder and characterized by DSC as summarized in Table 1.

TABLE 1

| | First Heat | First Heat | Tcg | Breadth of Processing |
|---|---|---|---|---|
| 3GT-1 (Wt %) | Tm (° C.) | Tg (° C.) | (° C.) | Window (° C.) |
| 0 | 240 | 79 | 140 | 61 |
| 25 | 240 | 69 | 143 | 74 |
| 50 | 235 | 63 | 114 | 51 |
| 75 | 230 | 51 | 89 | 38 |
| 100 | 228 | 47 | 72 | 25 |

Table 1 shows that blends of 3GT-1 and PET-2 provided broader processing windows than 100% of 3GT-1, with higher melt temperatures. A composition with about 25 weight % of 3GT-1 has a temperature profile similar to that of 100% of PET-2, with lower Tg.

### Preform Production

Blend compositions containing 3GT-1 (about 10 wt % of to about 70 wt %; Examples 2 to 4) were prepared. Preforms were injection molded as described below. Compositions having 0 weight % of 3GT-1 (Comparative Example C1) and 100 weight % of 3GT-1 (Comparative Example C5) were evaluated. Preforms (about 24.5 g; designed for a 20-ounce bottle) were produced on a single-cavity, Arburg 420C/ALLROUNDER 800-250 injection-molding machine. The screw configuration and process conditions were chosen to minimize the potential for transesterification. A 25-mm all-purpose screw was chosen to minimize melt-residence time in the extruder barrel. A color test before the trial indicated a melt-residence time of 75 seconds. There was no indication of any byproducts (e.g., acrolein, etc.) during this trial. Mold temperatures were maintained at approximately 15° C. Injection-molding processing conditions and results for each state are detailed in Table 2.

TABLE 2

| | Example | | | | |
|---|---|---|---|---|---|
| | C1 | 2 | 3 | 4 | C5 |
| 3GT-1 (weight %) | 0 | 27 | 68 | 54 | 100 |
| PET-1 (weight %) | 100 | 73 | 32 | 46 | 0 |

Injection Data

| | | | | | |
|---|---|---|---|---|---|
| Preform Weight (g) | 24.4 | 24.5 | 24.4 | 24.5 | 24.5 |
| Relative Humidity (%) | 63 | 57 | 67 | 57 | na |
| Dew Point (° F.) | 56.1 | 52 | 55.6 | 52 | na |
| Mold Temperature (° F.) | 60 | 57 | 47 | 50 | 50 |
| Ambient Temperature (° F.) | 69 | 68 | 67 | 68 | na |

Barrel Temperatures

| | | | | | |
|---|---|---|---|---|---|
| Feed (° C.) | 255 | 254 | 261 | 259 | 254 |
| Zone 2 (° C.) | 255 | 255 | 260 | 260 | 255 |
| Zone 3 (° C.) | 255 | 255 | 258 | 260 | 255 |
| Zone 4 (° C.) | 255 | 255 | 259 | 260 | 254 |
| Nozzle (° C.) | 255 | 255 | 260 | 260 | 255 |

Injection

| | | | | | |
|---|---|---|---|---|---|
| Injection Pressure 1 (bar) | 600 | 600 | 1000 | 1000 | 1000 |
| Injection Pressure 2 (bar) | 600 | 600 | 1000 | 1000 | 1000 |
| Injection Time (sec) | 2.1 | 2.0 | 3.5 | 3.5 | 3.6 |
| Injection Speed 1 (ccm/sec) | 12.0 | 12.0 | 6.0 | 6.0 | 6.0 |
| Injection Speed 2 (ccm/sec) | 10.0 | 10.0 | 6.0 | 6.0 | 6.0 |

Holding Pressure

| | | | | | |
|---|---|---|---|---|---|
| Switch-Over Point (ccm) | 9.0 | 9.0 | 9.0 | 9.0 | 9.0 |
| 1st Hold Pressure (bar) | 300.0 | 325.0 | 350.0 | 350.0 | 350.0 |
| 2nd Hold Pressure (bar) | 250.0 | 275.0 | 350.0 | 350.0 | 350.0 |
| 3rd Hold Pressure (bar) | 250.0 | 275.0 | 350.0 | 350.0 | 350.0 |
| 4th Hold Pressure (bar) | 200.0 | 250.0 | 250.0 | 250.0 | 250.0 |
| 2nd Hold Pressure Time (sec) | 2.0 | 2.0 | 2.0 | 2.0 | 2.0 |
| 3rd Hold Pressure Time (sec) | 3.0 | 3.0 | 3.0 | 3.0 | 3.0 |
| 4th Hold Pressure Time (sec) | 2.0 | 2.0 | 2.0 | 2.0 | 2.0 |
| Remain Cool Time (sec) | 10.0 | 12.0 | 17.0 | 17.0 | 18.5 |

Dosage

| | | | | | |
|---|---|---|---|---|---|
| Circumference Speed (m/min) | 10.0 | 20.0 | 10.0 | 10.0 | 10.0 |
| Back Pressure (bar) | 25.0 | 50.0 | 75.0 | 75.0 | 75.0 |
| Dosage Volume (ccm) | 26.5 | 26.5 | 26.5 | 26.5 | 26.5 |
| Dosage Time (sec) | 8.0 | 4.2 | 9.0 | 8.7 | 10.3 |
| Cushion (ccm) | 4.4 | 4.5 | 4.4 | 4.4 | 4.2 |

Adjustment Data

| | | | | | |
|---|---|---|---|---|---|
| Cycle Time (sec) | 24.3 | 25.2 | 31.7 | 31.7 | 33.3 |

### Free-Blown Balloons

A free-blow balloon study was performed on a unit developed by Plastic Technologies, Inc. Free-blowing is a blow molding operation in which the preforms are heated and blown in the absence of a mold cavity that defines a predetermined volume. Free-blowing allows the investigation of stretch ratios for the compositions. All preforms were heated on a Sidel SBO12 stretch-blow-molding machine and immediately brought to the free-blow station for this study.

The free-blow temperatures, pre-blow pressures and results are detailed in Table 3. All states were optimized independently. The aerial stretch ratio (axial stretch ratio x radial stretch ratio) was reported for each state. With compositions containing 3GT-1, the free-blow temperatures and pressures were all lower than the polyester copolymer (Comparative Example C1), potentially providing energy savings and a reduction in the overall environmental footprint. For example, the free-blow temperature with Example 3 was 71° C.; the blow pressure was 35 psi. In comparison, the free-blow temperature with C1 was 98° C. and the blow pressure was 50 psi.

TABLE 3

| | Example | | | | |
|---|---|---|---|---|---|
| | C1 | 2 | 3 | 4 | C5 |
| 3GT-1 (weight %) | 0 | 27 | 68 | 54 | 100 |
| PET-1 (weight %) | 100 | 73 | 32 | 46 | 0 |

Freeblown Balloon Volumes

| | | | | | |
|---|---|---|---|---|---|
| Preform Temperature (° C.) | 98 | 91 | 71 | 79 | 68 |
| Blow Pressure (psi) | 50 | 35 | 35 | 30 | 70 |
| Balloon Volume (CC) | 1250.0 | 2199.3 | 1988.1 | 2515.0 | 692.2 |

Freeblown Balloon Stretch Ratios

| | | | | | |
|---|---|---|---|---|---|
| Inside Axial | 3.2 | 4.3 | 4.2 | 4.5 | 2.4 |
| Inside Radial | 6.0 | 7.4 | 7.3 | 7.4 | 4.3 |
| Inside Areal | 19.1 | 31.5 | 30.5 | 33.3 | 10.6 |

The freeblown balloon produced with 100 weight % of PET-1 (Comparative Example C1) was larger than expected for the polyester copolymer (1250-mL actual vs. 592-mL target). The larger-than-expected volume for this freeblown balloon may be due to the lower IV of this water-grade resin which has slightly higher flow properties than a typical carbonated-soft-drink resin for which this preform was designed (0.76-IV vs.≧0.80-IV). Larger-volume freeblown balloons were also produced with each of the intermediate blend compositions (Examples 2-4) evaluated in this study.

The freeblown balloon produced with 100 weight % of 3GT-1 (comparative Example C5) most closely approached the targeted volume for the preform design used in this study. However, the endcap of this balloon did not fully orient during the freeblow process, indicating significant crystallization before the stretch-orientation process was complete.

The preforms containing blends of 3GT-1 had larger stretch ratios than C1 and also required lower temperatures and pressures during the freeblow process than the temperatures and pressures used for C1. Compositions comprising a blend of PET and 3GT provide areal stretch ratio greater than 22, greater than 25 or greater than 30. In comparison, Comparative Example C1 provides areal stretch ratio less than 20. Thus, blends of PET with 3GT, such as those comprising about 20 to about 70 weight % of 3GT, provide areal stretch ratio at least 1.5 times that for PET that does not contain 3GT.

### Bottle Production

Bottles were produced on a Sidel SBO12 stretch-blow-molding machine. The temperature zones were set independently. A temperature sensor in zone three determined the temperature of the preform immediately prior to stretch-blow-molding.

20-ounce bottles were produced for the control polyester copolymer resin and blend states. 24-ounce bottles were produced for the control polyester copolymer resin and blend states. A 24-ounce bottle was also produced for the 3GT-1 control. The optimized stretch-blow-molding processing conditions and results are detailed in Table 4 below.

A 20-ounce mold was standard for the 24.5-g preform used in this study. More uniform (visually and dimensionally) bottles of blend states Examples 2 through 4 were produced with the 24-ounce mold. The ability to stretch-blow-mold into a larger volume mold most likely results from the high stretch-ratio characteristics of the 3GT-1 blend compositions.

TABLE 4
Processing conditions for injection-stretch-blow-molding

| | 3GT-1 | | Preform |
|---|---|---|---|
| Example | (weight %) | Bottle (oz) | Temperature (° C.) |
| C6 | 0 | 20 | 94 |
| C7 | 0 | 24 | 104 |
| 8 | 54 | 20 | 76 |
| 9 | 54 | 24 | 75 |
| 10 | 27 | 20 | 85 |
| 11 | 27 | 24 | 88 |
| C12 | 100 | 24 | 65 |

24-oz bottles of 0 weight % of 3GT-1, 27 weight % of 3GT-1 and 54 weight % of 3GT-1 were evaluated to determine thermal stability in contact with a personal-care formulation. For this study, KERI lotion (original formula) was used to represent a typical personal-care, hand-cream formulation. The height and diameter of each bottle were measured prior to aging. For each of the three states evaluated, three bottles were left empty, three were filled with deionized water and three were filled with KERI lotion. The bottles were aged for 42 days in a room that was maintained at 37.8° C. (100° F.) and 90% relative humidity. Bottles were measured to determine shrinkage in height and diameter after 2 days, 13 days and 42 days. The average height, diameter and change for the bottles are reported in Table 5.

TABLE 5

| | | Height (cm) | | | Diameter (cm) | | |
|---|---|---|---|---|---|---|---|
| | | Time (days) | | | Time (days) | | |
| 3GT-1 (wt %) | Liquid | 0 | 42 | Δ Height (cm) | 0 | 42 | Δ Diameter (cm) |
| 0 | empty | 22.63 | 22.73 | −0.1 | 7.33 | 7.33 | 0 |
| 0 | lotion | 22.7 | 22.7 | 0 | 7.37 | 7.33 | 0.04 |
| 27 | empty | 22.6 | 22.6 | 0 | 7.4 | 7.33 | 0.07 |
| 27 | lotion | 22.6 | 22.5 | 0.1 | 7.4 | 7.3 | 0.1 |
| 54 | empty | 22.47 | 21.6 | 0.87 | 7.37 | 7.2 | 0.13 |
| 54 | lotion | 22.5 | 21.47 | 1.03 | 7.27 | 7.1 | 0.17 |

Excellent results were observed with 24-ounce bottles with 27 weight % 3GT-1. In addition to the uniform weight distribution and high clarity observed during production, the bottles with 27 weight % of 3GT-1 and the bottles with 0 weight % of 3GT-1 had no statistical difference in height or diameter after 42 days of aging.

1. An article comprising or produced from a thermoplastic polymer composition wherein
the article is a hollow shaped article;
the composition comprises, based on the weight of the composition, about 55% to about 99 weight % of a poly(ethylene terephthalate) and about 1 to about 45 weight % of a poly(trimethylene terephthalate);
each polymer is a homopolymer or copolymer; and
the composition does not contain a crystallization accelerator or nucleating agent.

2. The article of claim 1 wherein the composition comprises about 5 to about 35 weight % of the poly(trimethylene terephthalate).

3. The article of claim 2 wherein the article is an injection-stretch-blow-molded article and the composition comprises about 10 to about 30 weight % of the poly(trimethylene terephthalate).

4. The article of claim 3 wherein
the article has reduced heat deformation or shrinkage, as compared to an article produced from the poly(trimethylene terephthalate) or from a composition comprising more than 50 weight % of the poly(trimethylene terephthalate); and
the composition comprises about 15 to about 30 weight % of the poly(trimethylene terephthalate).

5. The article of claim 4 wherein
the article is heat stable at about 30 to about 55° C. and relative humidity of from about 60% to about 100%; and
the composition comprises about 20 to about 30 weight % of the poly(trimethylene terephthalate).

6. The article of claim 5 wherein
the article is heat stable at about 35 to about 45° C. and relative humidity of from about 80% to about 95%; and
the composition comprises about 20 to about 30 weight % of the poly(trimethylene terephthalate) homopolymer.

7. The article of claim 4 wherein the composition has Tg from about 40° C. to about 90° C. and Tcg from about 70° C. to about 150° C., as determined by differential scanning calorimetry by heating from room temperature to 280° C. using a heating rate of 10° C./min, holding at 280° C. for two minutes, cooling to below room temperature, and then reheating from room temperature to 280° C.

8. The article of claim 7 wherein the composition has Tg from about 45° C. to about 80° C. and Tcg from about 70° C. to about 130° C.

9. The article of claim 8 wherein the composition has Tg from about 65° C. to about 80° C. and Tcg from about 90° C. to about 150° C.

10. The article of claim 1 wherein the composition further comprises an additive selected from the group consisting of plasticizers, viscosity stabilizers, hydrolytic stabilizers, antioxidants, ultraviolet absorbers, ultraviolet stabilizers, anti-static agents, dyes, pigments, coloring agents, fire-retardants, lubricants, processing aids, slip additives, antiblock agents, release agents, inorganic fillers, acid copolymer waxes, TiO₂, optical brighteners, surfactant, or combinations of two or more thereof.

11. The article of claim 7 that is an injection-stretch-blow-molded closed end hollow article produced from a monolayer or multilayer structure comprising the composition.

12. The article of claim 7 that is an injection-stretch-blow-molded container produced from monolayer or multilayer structure comprising the composition and the article is blown bottle, blown vial, or blown jar.

13. The article of claim 12 wherein the composition provides an areal stretch ratio greater than 22 when an injection molded closed end hollow article is heated and blown in the absence of a mold cavity that defines a predetermined volume and the article does not contain acrolein.

14. The article of claim 1 comprising about 20 to about 30 weight % of the poly(trimethylene terephthalate) wherein the areal stretch ratio is at least 1.5 times that obtained using a composition that does not contain poly(trimethylene terephthalate).

15. A package comprising or produced from an article wherein the article is produced from a monolayer or multilayer structure comprising about 15 to about 30 weight % of the poly(trimethylene terephthalate) and poly(ethylene terephthalate).

16. The package of claim 15 wherein the article is an injection-stretch-blow-molded container produced from monolayer or multilayer structure comprising the composition and the article is blown bottle, blown vial, or blown jar.

17. The package of claim 16 comprising cosmetic, lotion, perfume, beverage, edible oil, syrup, sauce, mayonnaise, peanut butter, puree, vinegar, lemon juice, pharmaceutical, personal hygiene product, medicament, petroleum product, fuel, household chemical, agrochemical product, powder, granule, or other flowable solid.

18. The package of claim 16 wherein
the article has reduced heat deformation or shrinkage, as compared to an article produced from the poly(trimethylene terephthalate) or from a composition comprising more than 50 weight % of the poly(trimethylene terephthalate); and
the composition comprises about 15 to about 30 weight % of the poly(trimethylene terephthalate).

19. The package of claim 18 wherein
the article is heat stable at about 30 to about 55° C. and relative humidity of from about 60% to about 100%; and
the composition comprises about 20 to about 30 weight % of the poly(trimethylene terephthalate).
